(19) United States
(12) Patent Application Publication
(10) Pub. No.: US 2022/0179516 A1
(43) Pub. Date: Jun. 9, 2022

(54) COLLABORATIVE DISPLAYS

(71) Applicant: Hewlett-Packard Development Company, L.P., Spring, TX (US)

(72) Inventor: Sook Min Park, Palo Alto, CA (US)

(73) Assignee: Hewlett-Packard Development Company, L.P., Spring, TX (US)

(21) Appl. No.: 17/599,842

(22) PCT Filed: Jul. 23, 2019
(86) PCT No.: PCT/US2019/043015

§ 371 Date: Sep. 29, 2021

(51) Int. Cl. G06F 3/042; G03B 17/54; G09G 3/00

(52) U.S. Cl. CPC G06F 3/0425; G06F 2203/04102; G09G 3/001; G03B 17/54

(57) ABSTRACT

Examples of systems are described herein. In some examples, a system includes a projector, a camera, a touch sensitive mat, and a computing device. In some examples, the computing device may receive a first input from the camera corresponding to a first layer, a second input from the touch sensitive mat corresponding to a second layer, and a third input from a collaborating remote computing device corresponding to a third layer. In some examples, the computing device may render collaborative display data based on the first input, the second input, the third input, and a layer filter. In some examples, the collaborative display data is presented by the projector.

### BACKGROUND

The use of electronic devices has expanded. For example, a variety of computing devices are used for work, communication, and entertainment. Computing devices may be linked to a network to facilitate communication between users. For example, a smart phone may be used to send and receive phone calls, email, or text messages. A tablet device may be used to watch Internet videos. A desktop computer may be used to send an instant message over a network. Each of these types of communication offers a different user experience.

### BRIEF DESCRIPTION OF THE DRAWINGS

FIG. 1 is a diagram illustrating examples of electronic devices;

FIG. 2 is a block diagram illustrating an example of a remote server and a plurality of remote computing devices;

FIG. 3 is a block diagram of an example of a computing device that may be used in providing a collaborative display; and

FIG. 4 is a flow diagram illustrating an example of a method for rendering collaborative display data.

### DETAILED DESCRIPTION

Some approaches to collaboration with devices are limited in various aspects. For example, some approaches lack an ability to view co-created content by local (e.g., in-room) participants and remote participants. Some approaches cannot use horizontal and vertical surfaces for collaboration. Some approaches lack platform integration and/or do not allow saving collaborative sessions. Some approaches are not expandable, and some approaches lack an ability to rapidly communicate using different devices, such as laptops and phones. Some approaches lack portability.

Some examples of the techniques described herein may provide improved collaboration between computing devices. Some examples may provide projection capabilities to co-create content with a remote collaborator, provide startup with a collaboration application on a platform, provide portability to improve collaboration on horizontal surfaces, provide collaboration capability between local and/or remote computing devices, and/or enable combining multiple projector devices to form a virtual surface. Some examples of the techniques described herein may be beneficial by improving collaboration startup between computing devices and enhancing portability.

Some beneficial features of some examples of the techniques described herein may include utilizing a touch sensitive mat to use as a horizontal surface (e.g., horizontal virtual whiteboard surface) during collaboration. Some examples may provide improved startup via a collaboration application and/or platform that may provide coordination for collaboration, an ability to undo changes through the collaboration application, the creation of layers for inputs from various computing devices or users, and/or an ability to provide a save and exit function. The save and exit function may be activated with a single input in some examples. Some examples may provide portability such that a projector device may be used on horizontal and vertical surfaces. Some examples may enable a projection device to communicate with (e.g., link to) a variety of computing devices. Some examples may enable startup of a collaborative application when a recognized computing device is within a range. Some examples may provide linking multiple projector devices to provide an expanded virtual surface.

Throughout the drawings, identical reference numbers may designate similar, but not necessarily identical, elements. Similar numbers may indicate similar elements. When an element is referred to without a reference number, this may refer to the element generally, without necessary limitation to any particular drawing figure. The drawing figures are not necessarily to scale, and the size of some parts may be exaggerated to more clearly illustrate the example shown. Moreover, the drawings provide examples and/or implementations in accordance with the description; however, the description is not limited to the examples and/or implementations provided in the drawings.

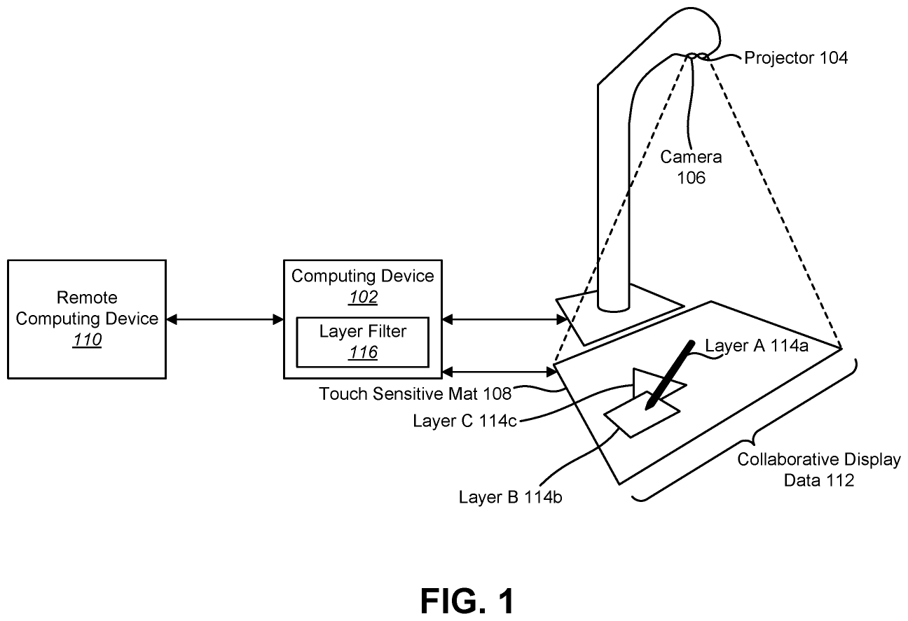

FIG. 1 is a diagram illustrating examples of electronic devices. For example, FIG. 1 shows a computing device 102, a projector 104, a camera 106, a touch sensitive mat 108, and a remote computing device 110. The computing device 102 is a device that includes a processor and memory with executable instructions. The memory may be a non-transitory machine-readable storage medium. Examples of the computing device 102 may include desktop computers, computer towers, laptop computers, tablet devices, smart phones, etc.

The projector 104 is a device for projecting images or image data. For example, the projector 104 may be a digital light projector that receives image data from the computing device 102 and projects the image data. For instance, the projector 104 may include a light source, image controller, and/or lens. Examples of the projector 104 include digital light processing (DLP) projectors and liquid crystal display (LCD) projectors. The projector 104 may be in electronic communication with the computing device 102. For example, the projector 104 may utilize a wired or wireless link to communicate with the computing device 102. Examples of wired links include Universal Serial Bus (USB) links, Ethernet links, High Definition Multimedia Interface (HDMI) links, etc. Examples of wireless links include Institute of Electrical and Electronics Engineers (IEEE) 802.11 or “Wi-Fi” links, cellular links, Bluetooth links, etc.

The camera 106 is a device for capturing optical images (e.g., video) and/or depth images. For instance, the camera 106 may include a sensor or sensors and a lens or lenses. In some examples, the sensor(s) may include light sensors, infrared (IR) sensors, depth sensors. Examples of the camera 106 include digital cameras, time-of-flight (TOF) cameras, etc. The camera 106 may be in electronic communication with the computing device 102. For example, the camera 106 may utilize a wired or wireless link to communicate with the computing device 102.

The touch sensitive mat 108 is a device for detecting contact with an object. For example, the touch sensitive mat 108 may detect contact with an object such as a hand, finger, stylus, electronic stylus, and/or other physical object. Some examples of the touch sensitive mat 108 may include capacitive touch mats or panels, resistive touch mats or panels, piezoelectric touch mats or panels, surface acoustic wave touch mats or panels, infrared touch mats or panels, etc. In some examples, the touch sensitive mat 108 may be flexible and/or rollable. The touch sensitive mat 108 may detect a location or locations of contact. The touch sensitive mat 108 may be in electronic communication with the computing device 102. For example, the touch sensitive mat 108 may utilize a wired or wireless link to communicate with the computing device 102. In some examples, the computing device 102 may be a part of a system that includes the computing device 102, the projector 104, the camera 106, and the touch sensitive mat 108. In some examples, the projector 104, camera 106, and/or touch sensitive mat 108 may be integrated into one device and/or may communicate with the computing device 102 with one link. In some examples, the projector 104, camera 106, and/or touch sensitive mat 108 may be separate devices that communicate with the computing device 102 with separate links.

In some examples, the projector 104 and the camera 106 may be situated in a housing. For example, the projector 104 and the camera 106 may be situated in a housing that includes an arm. In some examples, the touch sensitive mat 108 may be rolled and/or folded. In some examples, the touch sensitive mat 108 may be stowed in the housing when rolled or folded.

The computing device 102 may communicate with a remote computing device or remote computing devices 110. A remote computing device 110 is a computing device that is separate from the computing device 102. In some examples, the remote computing device 110 may be located outside of a room or building where the computing device 102 is housed. In some examples, the remote computing device 110 may be a computing device that utilizes a network connection or network connections to communicate with the computing device 102. For example, the remote computing device 110 may utilize a local area network (LAN) connection, a wide area network (WAN) connection, and/or an Internet connection to communicate with the computing device 102.

The computing device 102 may receive a first input from the camera 106 corresponding to a first layer. In the example of FIG. 1, layer A 114a is an example of the first layer. A layer is an image structure. For example, a layer may include image data, such as visual objects, photographs, writing, etc. A layer may be organized or stacked with another layer or layers to produce an image for presentation. For example, layers may be presented such that image data at a higher layer may be presented on top or in front of image data at a lower layer. For instance, when an area of image data of a higher layer overlaps with an area of image data of a lower layer, the image data of the higher layer in the overlapping area may be shown, while the image data of the lower layer in the overlapping area may be covered, suppressed, or removed in rendering. The first input from the camera 106 may include optical data. For example, the first input may include an image or images (e.g., video) from the field of view of the camera 106. In some examples, the first input may include an image or images (e.g., video) of the touch sensitive mat 108 and/or an object or objects between the touch sensitive mat 108 and the camera 106. For example, the input from the camera 106 may include video of a person's arm or hand interacting with the touch sensitive mat 108. In another example, the input from the camera 106 may include video of an object placed on the touch sensitive mat 108. In the example of FIG. 1, the input from the camera 106 includes an image of a stylus corresponding to layer A 114a.

The computing device 102 may receive a second input from the touch sensitive mat 108 corresponding to a second layer. In the example of FIG. 1, layer B 114b is an example of the second layer. The input from the touch sensitive mat 108 may include image data corresponding to a location or locations where contact with the touch sensitive mat 108 has been detected and/or is being detected. For example, the touch sensitive mat 108 may detect contact from a user's finger, from a stylus, or from another object. The touch sensitive mat 108 or the computing device 102 may produce image data corresponding to the contact location(s). In the example of FIG. 1, the input from the touch sensitive mat 108 includes an image of a rectangle or trapezoid corresponding to layer B 114b.

The computing device 102 may receive a third input from a collaborating remote computing device 110 corresponding to a third layer. A collaborating remote computing device is a remote computing device that is in communication with the computing device 102 to provide input for collaboration (e.g., a contribution to collaborative display data 112). In the example of FIG. 1, layer C 114c is an example of the third layer. In some examples, the third input may indicate an image or images provided by the remote computing device 110. For example, the remote computing device 110 may receive input from an input device. Examples of input devices include touch screens, touch pads, mice, keyboards, electronic styluses, cameras, controllers, etc. The remote computing device 110 may communicate the input and/or data based on the input to the computing device 102 as the third input. For example, the third input may include image data, programmatic objects, coordinates, etc. In the example of FIG. 1, the input from the remote computing device 110 includes an image of a triangle corresponding to layer C 114c.

The computing device 102 may render collaborative display data 112 based on the first input, the second input, the third input, and a layer filter 116. Collaborative display data 112 is data or an image based on a combination of data from the remote computing device 110 and data from the camera 106 and/or touch sensitive mat 108. In some examples, the collaborative display data 112 may be presented by the projector 104. In some examples, the collaborative display data 112 may be presented on the touch sensitive mat 108.

A layer filter 116 is data and/or instructions used to control how layers operate. In some examples, the layer filter 116 indicates a layer order. The layer order may set a ranking that indicates whether image data from a layer will cover image data from another layer. In the example of FIG. 1, layer A 114a is a highest, top, or front layer, layer B 114b is after layer A 114a in layer order or is a “middle” layer, and layer C 114c is after layer B 114b in layer order or is a lowest, bottom, or back layer. In this example, image data from layer A 114a covers image data from layer B 114b where overlapping, and image data from layer B 114b covers image data from layer C 114c where overlapping. In some examples, the layer order may be indicated by a layer number for each layer. For instance, layer A 114a may have a layer number of 1, layer B 114b may have a layer number of 2, and layer C 114c may have a layer number of 3. In other examples, the layers 114a-c may have a different layer order and/or layer numbers. In some examples, the layer order may be set based on a received input. For example, an input may be received from a user interface that indicates a layer order.

As used herein, ordinal numbers (i.e., “first,” “second,” “third,” etc.) may not necessarily imply an order. For instance, a third layer may be a top layer with a layer number of 1, a first layer may be a middle layer with a layer number of 2, and a second layer may be a bottom layer with a layer number of 3.

In some examples, the layer filter 116 indicates a layer selection for rendering. A layer selection indicates whether to show each of the layers. For example, the layer selection may indicate whether to show or hide each layer individually. In some examples, the layer selection may be a set of flags or bits, where each flag or bit value indicates whether to show or hide a corresponding layer. For example, if the layer selection indicates that layer B 114b is hidden, layer B 114b may be omitted in rendering the collaborative display data 112. In some examples, the layer selection may be set based on a received input. For example, an input may be received from a user interface that indicates the layer selection.

While one remote computing device 110 is illustrated in FIG. 1, multiple remote computing devices 110 may be utilized in some examples. For instance, each remote computing device 110 may provide an input to contribute to the collaborative display data 112. In some examples, each input may correspond to a different layer.

In some examples, a rolled state of the touch sensitive mat 108 may be utilized to switch between a horizontal mode and a vertical mode. In horizontal mode, the touch sensitive mat 108 may be utilized to capture input. In vertical mode, the touch sensitive mat 108 may not be utilized to capture input and/or the camera 106 may be utilized to capture input from a vertical surface. A rolled state may indicate whether the touch sensitive mat 108 is laid approximately flat or if the touch sensitive mat 108 is rolled up. In some examples, the touch sensitive mat 108 may use a sensor or sensors (e.g., touch sensors, pressure sensors, etc.) to determine whether the touch sensitive mat 108 is rolled up or laid out. For example, when the touch sensitive mat 108 is rolled up, the projector 104, camera 106, and/or computing device 102 may switch to vertical mode. When the touch sensitive mat 108 is not rolled up or is laid approximately flat, the projector 104, camera 106, and/or computing device 102 may switch to horizontal mode. In some examples, the touch sensitive mat 108 may be stowed in a housing with the projector 104 and/or camera 106 when rolled up. In some examples, the projector 104 and/or camera 106 may be aimed differently for horizontal and vertical modes. The aim may be changed mechanically and/or electronically. For example, different zones may be utilized to capture images and/or project images for horizontal mode and vertical mode.

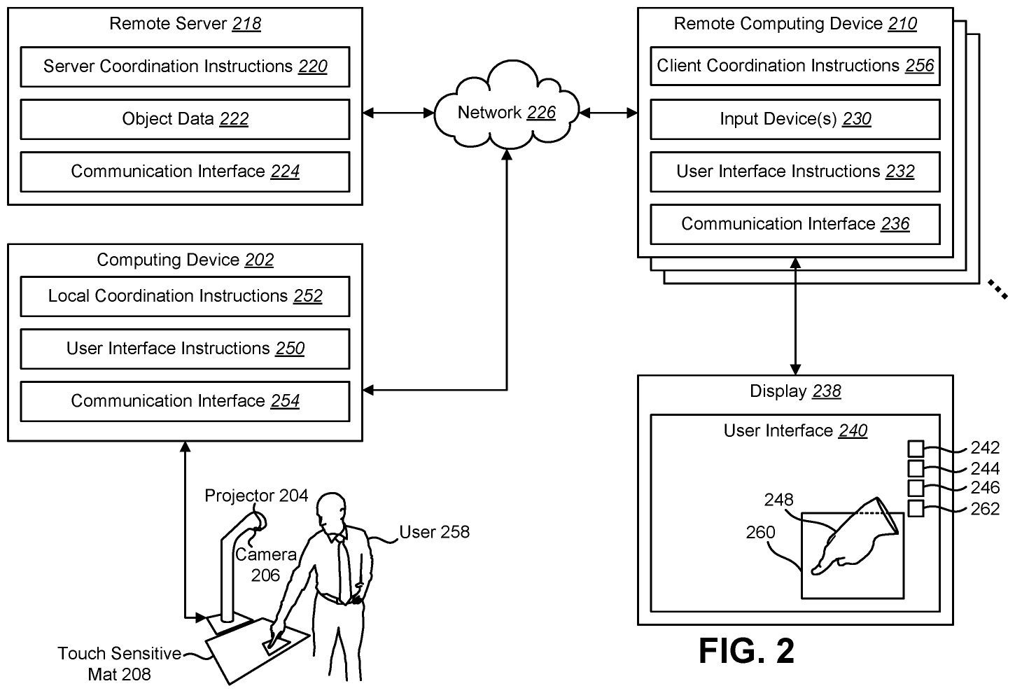

FIG. 2 is a block diagram illustrating an example of a remote server 218 and a plurality of remote computing devices 210. The remote computing devices 210 may be examples of the remote computing device 110 described in connection with FIG. 1. FIG. 2 also illustrates an example of a computing device 202, a projector 204, a camera 206, and a touch sensitive mat 208. The computing device 202, projector 204, camera 206, and touch sensitive mat 208 described in connection with FIG. 2 may be examples of the computing device 102, projector 104, camera 106, and touch sensitive mat 108 described in connection with FIG. 1.

The computing device 202 may include a processor and memory. The computing device 202 may include local coordination instructions 252, user interface instructions 250, and/or a communication interface 254. For example, the local coordination instructions 252 and the user interface instructions 250 may be stored in memory. The communication interface 254 may include hardware and/or machine-readable instructions to enable the computing device 202 to communicate with the remote server 218 and/or the remote computing devices 210 via a network 226. The communication interface 254 may enable a wired or wireless connection to the computing device 202 and/or to the remote computing devices 210.

In some examples, the local coordination instructions 252 may be executed by the processor to coordinate data exchange between the computing device 202 and the remote server 218 and/or remote computing devices 210. For example, the computing device may receive a first input from the camera 206. The first input may indicate an image object. An image object is an object based on input from the camera 206. For example, the image object may be data that is formatted for transfer and/or collaboration. In some examples, the computing device 202 may execute the local coordination instructions 252 to produce the image object based on the first input from the camera 206. In some examples, formatting the first input may include removing a portion of the first input, removing background from the first input, formatting the first input for transparency, formatting color of the first input (e.g., color coding the image data), labeling the first input, formatting the first input for an operation, and/or associating the first input with a layer. The computing device 202 may send the image object to the remote server 218 and/or to the remote computing devices 210.

In some examples, the computing device may receive a second input from the touch sensitive mat 208. The second input may indicate a writing object. A writing object is an object based on input from the touch sensitive mat 208. For example, the writing object may be data from the touch sensitive mat 208 that is formatted for transfer and/or collaboration. In some examples, the computing device 202 may execute the local coordination instructions 252 to produce the writing object based on the second input from the touch sensitive mat 208. In some examples, formatting the second input may include removing a portion of the second input, formatting the second input for transparency, formatting color of the second input (e.g., color coding image data corresponding to the second input), labeling the second input, formatting the second input for an operation, and/or associating the second input with a layer. The computing device 202 may send the writing object to the remote server 218 and/or to the remote computing devices 210.

In some examples, the computing device 202 may execute the local coordination instructions 252 to receive data or objects from the remote server 218 and/or from the remote computing devices 210. For example, a remote computing device 210 may send a third input or objects corresponding to a third input to the remote server 218 and/or to the computing device 202. In some examples, the computing device 202 may render collaborative display data based on the received third input and/or objects corresponding to a third input.

In some examples, the computing device 202 may include rendering instructions that may be included in the user interface instructions 250 or may be separate from the user interface instructions 250. For example, the computing device 202 may execute the rendering instructions to render the collaborative display data. In some examples, the computing device 202 may render a portion of the first input semi-transparently. For example, the computing device 202 may render, semi-transparently, image data or a portion of image data from the first input from the camera 206. In some examples, this may allow the image data or a portion of the image data from the camera 206 to be presented while reducing obstruction of other presented data (e.g., second input from the touch sensitive mat 208 and/or third input from a remote computing device 210). In some examples, an image object that is rendered semi-transparently or that is formatted to be rendered semi-transparently may be sent to the remote server 218 and/or the remote computing devices 210.

In some examples, the computing device 202 may render a portion of a figure depicted by the first input. A figure may be a physical object. An example of a physical object is a body or limb of a user 258. For example, the computing device 202 may render a portion of a body or limb of a user 258 depicted by the first input from the camera 206. For instance, first input from the camera 206 may depict a user's arm below the elbow. The computing device 202 may detect or recognize a portion of the first input corresponding to the user's hand and remove the image data that depicts the user's arm between the wrist and elbow. For instance, the computing device 202 may remove image data that depicts a user except for a user's hand or finger. In some examples, the computing device 202 may remove image data except for image data that depicts a stylus. In some examples, this may allow a portion of the image data from the camera 206 to be presented while reducing obstruction of other presented data (e.g., second input from the touch sensitive mat 208 and/or third input from a remote computing device 210). For instance, this may allow a user 258 to point to a part of the collaborative display data 112. In some examples, an image object that is rendered with a portion of a figure or that is formatted to be rendered with a portion of a figure may be sent to the remote server 218 and/or the remote computing devices 210.

In some examples, the computing device 202 may execute the user interface instructions 250 to produce a user interface. In some examples, the user interface may be sent to the projector 204. In some examples, the user interface may be presented on the touch sensitive mat 208 or another surface. For example, the user interface may be presented on the touch sensitive mat 208 and the computing device 202 may detect interaction with the user interface from the touch sensitive mat 208.

In some examples, the computing device 202 may be in communication with or coupled to a display (not shown) or other local device (e.g., tablet, touch screen, etc.). In some examples, the computing device 202 may present the user interface on the display or local device. In some examples, an input or inputs may be provided to the computing device from the display or local device. For example, the local device may provide writing or drawing inputs using a touchscreen. The local device may provide inputs for a user interface control or controls described herein in some examples.

In some examples, the computing device 202 may execute the user interface instructions 250 to produce a user interface control or controls. Examples of user interface controls include an undo control, a redo control, a save and exit control, and a layer filter control. In some examples, the computing device 202 may present a save and exit control. In some examples, the computing device 202 may, in response to an activation of the save and exit control, exit a collaboration application and transmit an instruction to the remote server 218 to cause the remote server 218 to store data based on the first input and the second input. For example, the remote server 218 may store the first input, object(s) based on the first input, the second input, object(s) based on the second input, the third input, and/or object(s) based on the third input as object data 222 in response to receiving the instruction.

In some examples, the first input, object(s) based on the first input, the second input, object(s) based on the second input, the third input, and/or object(s) based on the third input may be stored in association with a collaboration session. A collaboration session is a record of collaboration between the computing device 202 and a remote computing device 210 or remote computing devices 210. The collaboration session may be provided by the remote server 218. For example, after a collaboration session, the computing device 202 and/or the remote computing device(s) 210 or another computing device may retrieve and/or view the collaboration session. In some examples, the collaboration session may be viewed with a layer filter. For example, due to the inputs being stored as object data 222, individual layers may be shown, hidden, re-ordered, and/or presented as semi-transparent. In some examples, the remote server 218 may also store other data (e.g., audio data, video data, etc.) associated with the collaboration session.

In some examples, the computing device 202 may render an operation based on the third input. For example, the computing device 202 may render data from the third input, such as drawings, writings, pictures, etc. For instance, the computing device 202 may add writing to the user interface based on the third input from a remote computing device 210. In some examples, the computing device 202 may receive an undo instruction from the remote server 218. For example, a remote computing device 210 may send an instruction to the remote server 218 to undo a previous operation that was rendered by the computing device. The remote server 218 may send the undo instruction to the computing device 202. The computing device 202 may undo the operation in response to the undo instruction. For instance, the computing device 202 may remove the writing or drawing. In some examples, the remote server 218, the remote computing device(s) 210, and/or the computing device 202 may maintain a history of operations that can be undone or redone.

Activation of the redo control 244 may cause the remote computing device 210 to send a redo instruction to the remote server 218 and/or the computing device 202. The remote server 218 and/or computing device 202 may redo a last undone operation (e.g., a last undone operation based on the third input or a last undone operation based on any input).

Activation of the layer filter control may provide options for re-ordering layers, for presenting a layer or layers semi-transparently, for hiding or showing a layer or layers, etc. In some examples, the layer filter control may apply to the user interface(s) for the computing device 202 (e.g., a user interface presented by the projector 204 and/or a user interface on another local device). In some examples, the layer filter control may apply to the user interface(s) of the computing device 202 and/or the remote computing device(s) 210.

The remote server 218 may include a processor and memory. The remote server 218 may include server coordination instructions 220, object data 222, and/or a communication interface 224. For example, the server coordination instructions 220 and the object data 222 may be stored in memory. In some examples, the server coordination instructions 220 may be executed by the processor. For example, the remote server 218 may execute the server coordination instructions 220 to coordinate data and/or instructions between the computing device 202 and the remote computing device 210 or remote computing devices 210. For instance, the remote server 218 may receive an input or inputs or corresponding object(s) from the computing device 202 and/or from the remote computing device(s) 210, which may be stored as object data 222 in some examples. In some examples, the remote server 218 may relay data and/or instructions between the remote computing device(s) 210 and the computing device 202. For example, the remote server 218 may execute the server coordination instructions 220 to relay third input(s) or object(s) based on the third input(s) from the remote computing device(s) to the computing device 202. The communication interface 224 may include hardware and/or machine-readable instructions to enable the remote server 218 to communicate with the computing device 202 and/or the remote computing devices 210 via a network 226. The communication interface 224 may enable a wired or wireless connection to the computing device 202 and/or to the remote computing devices 210.

The remote computing devices 210 may each include a processor and memory (e.g., a non-transitory computer-readable medium). Each of the remote computing devices 210 may include an input device or input devices 230, client coordination instructions 256, user interface instructions 232, and/or a communication interface 236. In some examples, the user interface instructions 232 may be stored in the memory (e.g., non-transitory computer-readable medium) and may be executable by the processor. Each communication interface 236 may include hardware and/or machine-readable instructions to enable the respective remote computing device 210 to communicate with the remote server 218 and/or the computing device 202 via the network 226. The communication interface 236 may enable a wired or wireless connection with the computing device 202 and/or with the remote server 218.

The input device(s) 230 may capture or sense inputs. Examples of the input device(s) 230 include touch screens, touch pads, mice, keyboards, electronic styluses, cameras, controllers, etc. In some examples, the input device(s) 230 may convert inputs from the input device(s) 230 into objects and/or image data. For instance, the input device(s) 230 may utilize the inputs from the input device(s) 230 to determine data and/or object(s) (e.g., writing objects, image objects, character objects, etc.). The data and/or object(s) may be sent to the remote server 218. The remote server 218 may store the data and/or object(s) as object data 222.

In some examples, a remote computing device 210 may include and/or may be coupled to a display 238. For example, the display 238 may be integrated into the remote computing device 210 or may be a separate device. The display 238 is a device for presenting electronic images. Some examples of the display 238 may include liquid crystal displays (LCDs), light emitting diode (LED) displays, organic light emitting diode (OLED) displays, plasma displays, touch screens, monitors, projectors, etc. In some examples, the display may present a user interface 240.

In some examples, the remote computing device(s) 210 may include client coordination instructions 256. The remote computing device 210 may execute the client coordination instructions 256 to coordinate with the remote server 218 and/or the computing device 202. For example, the client coordination instructions 256 may be executed to send a third input(s) or object(s) based on the third input(s) to the remote server 218 and/or the computing device 202. In some examples, the client coordination instructions 256 may be executed to receive a first input(s) or object(s) based on the first input(s) from the remote server 218 and/or the computing device 202. For instance, the remote computing device(s) 210 may receive a first input from a camera 206 and/or object(s) based on the first input from the remote server 218 and/or computing device 202. In some examples, the client coordination instructions 256 may be executed to receive a second input(s) or object(s) based on the second input(s) from the remote server 218 and/or the computing device 202. For instance, the remote computing device(s) 210 may receive a second input from a touch sensitive mat 208 and/or object(s) based on the second input from the remote server 218 and/or computing device 202.

In some examples, the remote computing device 210 may render and/or present a portion of the first input semi-transparently. For example, the remote computing device 210 may render, semi-transparently, image data or a portion of image data from the first input from the camera 206. In some examples, this may allow the image data or a portion of the image data from the camera 206 to be presented while reducing obstruction of other presented data (e.g., second input from the touch sensitive mat 208 and/or third input from a remote computing device 210). In the example illustrated in FIG. 2, a hand 248 is presented semi-transparently in the user interface 240, which allows another object 260 to be viewed concurrently.

In some examples, the remote computing device 210 may render and/or present a portion of a figure depicted by the first input. For example, the remote computing device 210 may render a portion of a body or limb of a user 258 depicted by the first input from the camera 206. For instance, the remote computing device 210 may present a hand 248 of the user 258 without showing the arm of the user 258. In some examples, this may allow a portion of the image data from the camera 206 to be presented while reducing obstruction of other presented data. For example, an object 260 from a second input from the touch sensitive mat 208 may be presented without being obstructed by the user's arm. In some examples, a third input from the remote computing device 210 may also be presented.

In some examples, the remote computing device 210 may execute the user interface instructions 232 to produce a user interface 240. In some examples, the user interface 240 may be presented on the display 238.

In some examples, a third input or inputs may be provided to the remote computing device 210 from the user interface 240. For example, writing or drawing inputs may be provided using a touchscreen. In some examples, the user interface 240 may provide inputs for a user interface control or controls.

In some examples, the remote computing device 210 may execute the user interface instructions 232 to produce a user interface control or controls. Examples of user interface controls include an undo control 242, a redo control 244, a save and exit control 246, and/or a layer filter control 262. In some examples, the remote computing device 210 may present a save and exit control 246. In some examples, the remote computing device 210 may, in response to an activation of the save and exit control 246, exit a collaboration application and transmit an instruction to the remote server 218 to cause the remote server 218 to store data based on the third input. For example, the remote server 218 may store the first input, object(s) based on the first input, the second input, object(s) based on the second input, the third input, and/or object(s) based on the third input as object data 222 in response to receiving the instruction.

In some examples, the first input, object(s) based on the first input, the second input, object(s) based on the second input, the third input, and/or object(s) based on the third input may be stored in association with the collaboration session.

Activation of the undo control 242 may cause the remote computing device 210 to send an undo instruction to the remote server 218 and/or the computing device 202. The remote server 218 and/or computing device 202 may undo a last operation (e.g., a last operation based on the third input or a last operation based on any input). Activation of the redo control 244 may cause the remote computing device 210 to send a redo instruction to the remote server 218 and/or the computing device 202. The remote server 218 and/or computing device 202 may redo a last undone operation (e.g., a last undone operation based on the third input or a last undone operation based on any input).

Activation of the layer filter control 262 may provide options for re-ordering layers, for presenting a layer or layers semi-transparently, for hiding or showing a layer or layers, etc. In some examples, the layer filter control 262 may apply to the user interface 240 for one remote computing device 210. In some examples, the layer filter control 262 may apply to the user interface(s) of the computing device 202 and/or other remote computing device(s) 210.

In some examples, the local coordination instructions 252 may be an example of a collaboration application that may be executed to facilitate collaboration with the remote computing device(s) 210. In some examples, the client coordination instructions 256 may be another example of a collaboration application that may be executed to facilitate collaboration with the computing device 202. In some examples, the server coordination instructions 220 may be an example of instructions for a platform that interoperates with a collaboration application on the computing device 202 and/or on the remote computing device(s) 210 to facilitate (e.g., intermediate, relay) collaboration between the computing device 202 and the remote computing device(s) 210.

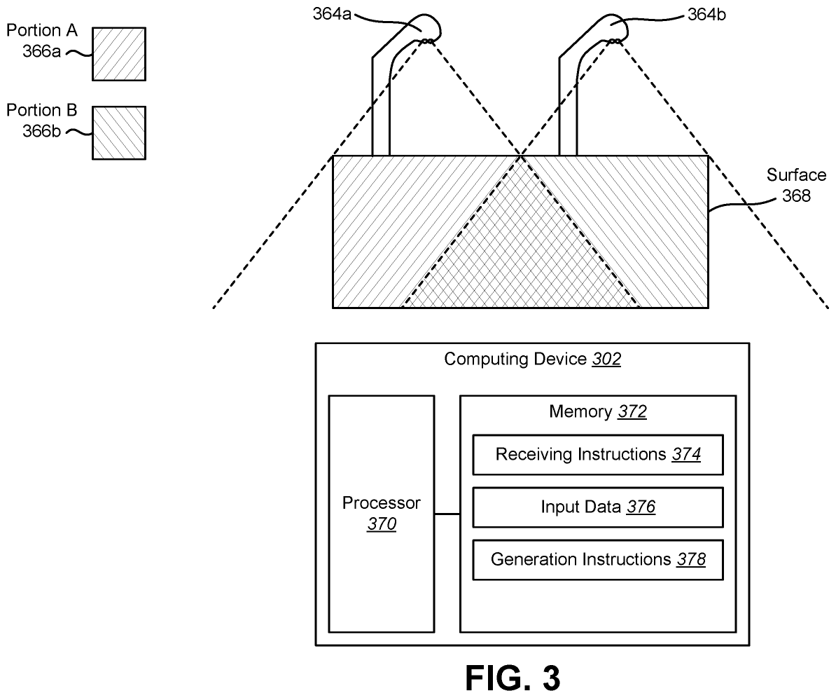

FIG. 3 is a block diagram of an example of a computing device 302 that may be used in providing a collaborative display. The computing device 302 may be an electronic device, such as a personal computer, a server computer, a smartphone, a tablet computer, etc. The computing device 302 may be an example of the computing device 102 described in connection with FIG. 1 and/or may be an example of the computing device 202 described in connection with FIG. 2. The computing device 302 may perform an operation or operations described in connection with FIG. 1 and/or FIG. 2. In some examples, a remote server and/or a remote computing device may include similar components as the computing device 302.

The computing device 302 may include and/or may be coupled to a processor 370 and/or a memory 372. In some examples, the computing device 302 may be in communication with (e.g., coupled to, have a communication link with) a remote server and/or remote computing devices. The computing device 302 may include additional components (not shown) and/or some of the components described herein may be removed and/or modified without departing from the scope of this disclosure.

The processor 370 may be any of a central processing unit (CPU), a digital signal processor (DSP), a semiconductor-based microprocessor, graphics processing unit (GPU), field-programmable gate array (FPGA), an application-specific integrated circuit (ASIC), and/or other hardware device suitable for retrieval and execution of instructions stored in the memory 372. The processor 370 may fetch, decode, and/or execute instructions (e.g., generation instructions 378) stored in the memory 372. In some examples, the processor 370 may include an electronic circuit or circuits that include electronic components for performing a function or functions of the instructions (e.g., generation instructions 378). In some examples, the processor 370 may perform one, some, or all of the functions, operations, elements, methods, etc., described in connection with one, some, or all of FIGS. 1-4.

The memory 372 may be any electronic, magnetic, optical, or other physical storage device that contains or stores electronic information (e.g., instructions and/or data). The memory 372 may be, for example, Random Access Memory (RAM), Electrically Erasable Programmable Read-Only Memory (EEPROM), a storage device, an optical disc, and the like. In some examples, the memory 372 may be volatile and/or non-volatile memory, such as Dynamic Random Access Memory (DRAM), EEPROM, magnetoresistive random-access memory (MRAM), phase change RAM (PCRAM), memristor, flash memory, and the like. In some implementations, the memory 372 may be a non-transitory tangible machine-readable storage medium, where the term “non-transitory”does not encompass transitory propagating signals. In some examples, the memory 372 may include multiple devices (e.g., a RAM card and a solid-state drive (SSD)).

In some examples, the computing device 302 may include a communication interface (not shown in FIG. 3) through which the processor 370 may communicate with an external device or devices (not shown), for instance, to receive and store information (e.g., input data 376) corresponding to the computing device 302, corresponding to a remote server device, and/or corresponding to a remote computing device(s). The communication interface may include hardware and/or machine-readable instructions to enable the processor 370 to communicate with the external device or devices. The communication interface may enable a wired or wireless connection to the external device or devices. The communication interface may further include a network interface card and/or may also include hardware and/or machine-readable instructions to enable the processor 370 to communicate with various input and/or output devices, such as projector(s), camera(s), a touch sensitive mat, a keyboard, a mouse, a display, another computing device, electronic device, smart phone, tablet device, etc., through which a user may input instructions and/or data into the computing device 302.

In the example illustrated in FIG. 3, the computing device 302 may communicate with a first projector device 364a and a second projector device 364b. In this example, the projector devices 364a-b are mounted to a surface 368. In some examples, the projector devices 364a-b may be mounted separately from the surface. In some examples, the surface 368 may be a vertical surface. In some examples, the surface 368 is a whiteboard. A whiteboard may be used for writing and/or drawing with markers (e.g., dry-erase markers). Each of the projector devices 364a-b may include a projector and a camera. While two projector devices 364a-b are illustrated in the example of FIG. 3, more or fewer projector devices 364 may be utilized.

In the example illustrated in FIG. 3, the first projector device 364a may have a camera field of view and/or projection area that covers portion A 366a of the surface 368. The second projector device 364b may have a camera field of view and/or projection area that covers portion B 366b of the surface 368. In some examples, portion A 366a may overlap with portion B 366b. In some examples, a first portion covered by a first projector device may not overlap with a second portion covered by a second projector device.

In some examples, the memory 372 of the computing device 302 may store receiving instructions 374. The processor 370 may execute the receiving instructions to receive, from a first projector device 364a, a first camera input corresponding to portion A 366a of a surface 368. The processor 370 may execute the receiving instructions to receive, from a second projector device 364b, a second camera input corresponding to portion B 366b of the surface 368.

The first camera input and the second camera input may be stored as input data 376 in the memory 372. For example, the first camera input may include an image or images (e.g., video) of portion A 366a and the second camera input may include an image or images (e.g., video) of portion B 366b.

In some examples, the processor 370 may execute the generation instructions 378 to generate a virtual surface corresponding to portion A 366a and portion B 366b of the surface 368. The virtual surface is an interactive surface corresponding to an actual surface 368. In the example described in connection with FIG. 3, the virtual surface may be generated based on a combination of inputs, where each of the inputs corresponds to a portion of the surface 368. The virtual surface may be utilized for collaboration of different inputs (e.g., first input(s), second input(s), and/or third input(s) described in connection with FIGS. 1 and 2).

In some examples, the receiving instructions 374 are executable to receive an input from a collaborating remote computing device. In some examples, the generation instructions 378 are executable to determine a projector mapping based on a location of the input in relation to the virtual surface. For example, the input from the collaborating remote computing device may be located in relation to the virtual surface that corresponds to the surface 368. The projector mapping is a mapping between the input and a projector device or projector devices 364a-b. In some examples, the projector mapping may be determined based on a boundary corresponding to the virtual surface. For example, the virtual surface may be divided into zones corresponding to each projector device. For instance, with two projector devices 364a-b, the virtual surface may be divided into halves, where input in the first half is mapped to the first projector 364a for presentation and input in the second half is mapped to the second projector 364b for presentation. In some examples, if an input is in the overlap between portion A 366a and portion B 366b, the input may be projected by the first projector device 364a and/or the second projector device 364b.

The computing device 302 may send image data based on the projector mapping. For example, the computing device 302 may send image data (e.g., pixels) corresponding to an input to a projector device 364a-b according to the mapping.

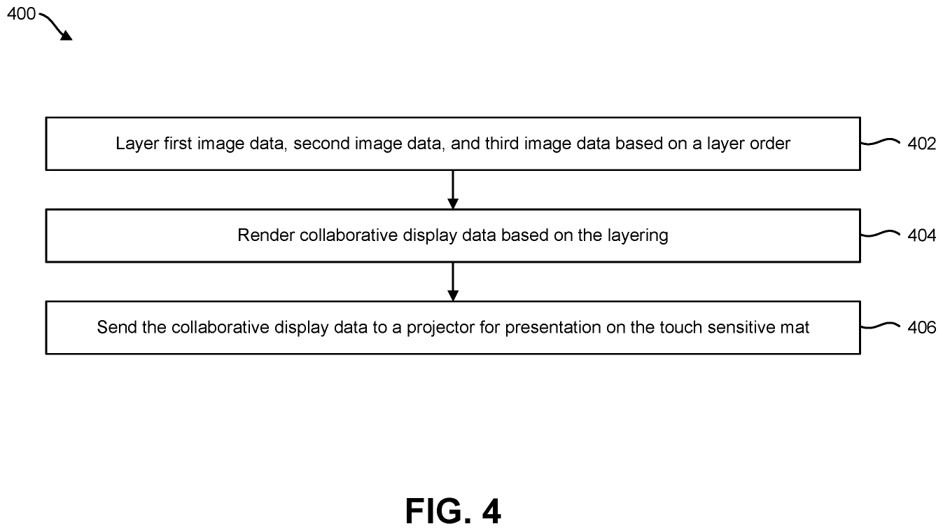

FIG. 4 is a flow diagram illustrating an example of a method 400 for rendering collaborative display data. The method 400 and/or a method 400 element or elements may be performed by a computing device. For example, the method 400 may be performed by the computing device 102 described in connection with FIG. 1, by the computing device 202 described in connection with FIG. 2, and/or by the computing device 302 described in connection with FIG. 3.

The computing device may layer 402 first image data, second image data, and third image data based on a layer order. This may be accomplished as described in connection with FIG. 1. For example, the first image data may be based on a first input from a camera, the second image data may be based on a second input from a touch sensitive mat, and the third image data may be based on a third input from a collaborating remote computing device. The layer order may be indicated by a layer filter in some examples.

The computing device may render 404 collaborative display data based on the layering. This may be accomplished as described in connection with FIG. 1. For example, the computing device may generate pixel data based on the first image data, the second image data, the third image data, and the layering. For instance, when image data from different inputs overlaps, the image data with the highest layer in the set of overlapping image may be utilized as pixel data for the overlapping area. In some examples, the second image data may depict a figure. Rendering 404 may include removing a portion of the second image data to render hand image data.

The computing device may send 406 the collaborative display data to a projector for presentation on the touch sensitive mat. This may be accomplished as described in connection with FIG. 1. For example, the computing device may send the collaborative display data to a projector via a wired or wireless link. In some examples, the camera may be housed with the projector.

In some examples, the method 400 may include switching between a horizontal mode and a vertical mode based on a rolled state of the touch sensitive mat. For example, when the touch sensitive mat is rolled up, the projector device and/or computing device may switch to vertical mode. In some examples, when the touch sensitive mat is not rolled up (e.g., is laid out), the projector device and/or computing device may switch to horizontal mode.

In some examples of the techniques described herein, a projector device may be utilized in a vertical mode. The projector device may be mounted on top of a whiteboard with magnets or magnetic braces that may be detachable. In some examples, the projector device may be charged while mounted in this mode. The projector device may be activated by pressing an on-off switch and a computing device may present the whiteboard for viewing via a remote server platform. In some examples, a remote computing device may present the whiteboard if given permission through the platform for collaboration. The computing device may be a laptop computer with a collaboration application in some examples. In some examples, the computing device may be a smart phone. The smart phone may present the whiteboard via a collaboration application (e.g., a mobile collaboration application) that may grant permission for an authorized user. In some examples, the projector device may be paired with a computing device with a collaboration application that interoperates with a platform. In some examples, a virtual surface and/or collaborative display data may be brought into a conference call through a setting of a touch interface of the computing device.

In some examples of the techniques described herein, a projector device may be utilized in a horizontal whiteboard mode. A computing device (e.g., laptop computer) may be utilized for sharing slides and the projector device with a horizontal writing surface (e.g., touch sensitive mat) may be used for note-taking as well as sharing brainstorming to remote computing devices. The projector device may connect to the computing device (e.g., laptop) for power and/or may syncs with peer to peer communication technology for transferring data. In some examples, the computing device may be a smart phone. The projector device may be in direct communication with an application and/or platform on a computing device and/or smart phone for communicating the contents of the brainstorming session to the remote computing device(s). The projector device may project content from the remote computing device(s) with permission through a collaboration application of the computing device that is linked to the projector device. The projector device may have communication capabilities for establishing a connection for onset of data transfer, streaming live content onto a platform for sharing with remote computing device(s). In some examples, a smart phone may not be utilized as the computing device. For example, a speaker, microphone, and a computing device with a collaboration application that can communicate like an Internet Protocol (IP) phone with a rollable touch sensitive mat may be utilized as an all-in-one collaboration device.

In some examples, the projector device may be plugged into a device with a battery when the projector device is mounted on a whiteboard or a charging base. A touch sensitive mat (e.g., a rollable capacitive touch mat) may extend from a base of the projector device when the projected image is to be projected onto the touch sensitive mat. In some examples, the touch sensitive mat may be rolled into the base of the projector device. In some examples, when the touch sensitive mat is rolled in, the projector device may switch from horizontal mode to the vertical whiteboard mode. In some examples, input from the camera may be utilized in vertical mode. When the touch sensitive mat is rolled out, the input from the touch sensitive mat may be utilized.

In some examples, a projector device may be linked (e.g., paired) with a computing device through driver instructions or with a universal serial bus (USB) dongle. If the linked computing device is within a distance (e.g., less than 30 feet, less than 20 feet, less than 10 feet, less than 5 feet, etc.), which may be detected through infrared signaling in some examples, switching on the projector device may activate a collaboration application. In some examples, activating the collaboration application may create a new collaboration session with a platform. Permissions may be set by the computing device that initiated the collaboration session. In some examples, the permissions may indicate which remote computing device(s) and/or user(s) may access a stored session. In some examples, the session may be stored in private cloud storage for access by a user or users.

It should be noted that while various examples of systems and methods are described herein, the disclosure should not be limited to the examples. Variations of the examples described herein may be implemented within the scope of the disclosure. For example, functions, aspects, or elements of the examples described herein may be omitted or combined.

1. A system, comprising:
a projector;
a camera;
a touch sensitive mat; and
a computing device to:
receive a first input from the camera corresponding to a first layer, a second input from the touch sensitive mat corresponding to a second layer, and a third input from a collaborating remote computing device corresponding to a third layer; and
render collaborative display data based on the first input, the second input, the third input, and a layer filter, wherein the collaborative display data is presented by the projector.

2. The system of claim 1, wherein the layer filter indicates a layer order.

3. The system of claim 1, wherein the layer filter indicates a layer selection for rendering.

4. The system of claim 1, wherein the collaborative display data is presented on the touch sensitive mat.

5. The system of claim 1, wherein the computing device is to render a portion of the first input semi-transparently.

6. The system of claim 1, wherein the computing device is to render a portion of a figure depicted by the first input.

7. The system of claim 1, wherein the first input indicates an image object and the second input indicates a writing object, and wherein the computing device is to send the image object and the writing object to a remote server.

8. The system of claim 1, wherein the computing device is to present a user interface control, and is to exit a collaboration application and transmit an instruction to a remote server to cause the remote server to store data based on the first input and the second input in response to an activation of the user interface control.

9. The system of claim 1, wherein the computing device is to:
render an operation based on the third input;
receive an undo instruction from a remote server; and
undo the operation in response to the undo instruction.

10. A computing device, comprising:
a processor;
a memory in electronic communication with the processor;
instructions stored in the memory, the instructions being executable to:
receive, from a first projector device, a first camera input corresponding to a first portion of a surface;
receive, from a second projector device, a second camera input corresponding to a second portion of the surface; and
generate a virtual surface corresponding to the first portion and the second portion of the surface.

11. The computing device of claim 10, wherein the surface is a whiteboard.

12. The computing device of claim 11, wherein the instructions are executable to:
receive an input from a collaborating remote computing device;
determine a projector mapping based on a location of the input in relation to the virtual surface; and
send image data based on the projector mapping.

13. A method, comprising:
layering first image data, second image data, and third image data based on a layer order, wherein the first image data is based on a first input from a camera, the second image data is based on a second input from a touch sensitive mat, and the third image data is based on a third input from a collaborating remote computing device;
rendering collaborative display data based on the layering; and
sending the collaborative display data to a projector for presentation on the touch sensitive mat, wherein the camera is housed with the projector.

14. The method of claim 13, wherein the touch sensitive mat is rollable.

15. The method of claim 13, further comprising switching between a horizontal mode and a vertical mode based on a rolled state of the touch sensitive mat.
